(19) United States
(12) Patent Application Publication
(10) Pub. No.: US 2019/0112564 A1
(43) Pub. Date: Apr. 18, 2019

(54) INFUSED ALCOHOLIC BEVERAGE

(71) Applicant: Keith Cyzen, Glen Ellyn, IL (US)

(72) Inventor: Keith Cyzen, Glen Ellyn, IL (US)

(21) Appl. No.: 16/159,145

(22) Filed: Oct. 12, 2018

Related U.S. Application Data
(60) Provisional application No. 62/571,658, filed on Oct. 12, 2017.

(51) Int. Cl. C12G 3/06

(52) U.S. Cl. CPC C12G 3/06

(57) ABSTRACT

The present invention relates to a ready-to-drink alcoholic beverage comprising a distilled spirit and at least one Aloaceae source.

### CROSS REFERENCE TO RELATED APPLICATION

Priority is claimed to U.S. Provisional Patent Application No. 62/571,658, filed Oct. 12, 2017, the entire disclosure of which is incorporated herein by reference.

### FIELD OF THE DISCLOSURE

The disclosure relates generally to a ready-to-drink alcoholic beverage. More particularly, the disclosure relates to a ready-to-drink alcoholic beverage including a distilled spirit and at least one Aloaceae source.

### BACKGROUND

There exists a wide variety of alcoholic beverages that are provided and consumed across the globe. Some of the most widely consumed beverages include beer, wine, and spirits (i.e. liquors). Each of these classifications of beverages has a wide range of beverages within them, manufactured by a vast number of suppliers. For example, there are dark and light beers, red, white, rosé, and sparkling wines, and various types of spirits, such as vodka, rum, whiskey, gin, tequila, and brandy.

The term “spirit” generally refers to a distilled beverage containing no added sugar at least 20% alcohol by volume (ABV). Distilled spirits are produced through the distillation of grains, fruits, or vegetables that have previously undergone alcoholic fermentation. The process of distillation purifies the solution by removing diluents, such as water, in order to increase its ABV. As such, spirits do not include beer, wine, cider, and various other alcoholic beverages, as these are fermented, but not distilled, giving them a lower ABV.

Over the past few decades, infused spirits have become increasingly popular. These spirits are typically infused with various flavors to provide the consumer with a more personalized and enjoyable experience in the selection, preparation, and consumption of these spirits, as well as cocktails made therefrom. Examples of flavors used in commercially available spirits include lemon, lime, orange, tangerine, clementine, grapefruit, raspberry, strawberry, blueberry, vanilla, black currant, chili pepper, cherry, apple, cinnamon, coffee, chocolate, pear, peach, passion fruit, pomegranate, mango, banana, pineapple, coconut, mint, melon, and rose.

While these flavored spirits do provide an enhanced experience for the consumer in addition to the effects of the spirit itself, the various drawbacks due to excessive alcohol consumption still exist. For example, excessive alcohol consumption can cause dehydration, drowsiness, indigestion, dry mouth, headaches, increased blood pressure, decreased immune response, decreased mental clarity, and many other short-term physiological, and even psychological, disruptions that can last for hours after consumption of the alcoholic beverage. Colloquially referred to as a “hangover,” these short-term disruptions can last up to more than twenty-four hours and can greatly affect a consumer's productivity and attention until the symptoms subside.

Aloe vera is a plant species of the genus Aloe L. and the family Aloaceae (sometimes referred to as Asphodelaceae). Other species of the Aloe genus include, but are not limited to, Aloe arborescens, Aloe ferox, Aloe graminicola, Aloe perryi, Aloe schoenlandi, Aloe secundiflora, and Aloe succotrina. A. vera and other members of the Aloe plant genus are known to grow in tropical climates and are cultivated for various reasons, such as medicinal uses. For example, the history of the use of the A. vera plant as an herbal remedy dates back to at least the 18^{th} century. The health benefits of aloe vera are often attributed to aloe mucilaginous polysaccharides (AMPs). The most common polysaccharides are glucomannans. For example, glucomannans found in aloe vera have been found to interact with growth factor receptors on fibroblasts, stimulating its activity and proliferation, which in turn increases collagen synthesis. Thus, aloe vera and other members of the Aloe plant genus, such as Aloe ferox, have traditionally been used for topical treatments to heal and soothe burns and frostbite, as well as to treat acne and various other sources of inflammation or infection of the skin, such as psoriasis, cold sores, and seborrheic dermatitis (i.e. dandruff). Numerous commercial personal care products include aloe vera in the formulation to claim its soothing, moisturizing, and healing properties.

Aloe vera, as well as other species of the Aloe genus, can also be found beverages, dietary supplements, laxatives, and various other products available for human consumption.

### SUMMARY OF THE INVENTION

The disclosure provides a ready-to-drink alcoholic beverage including a distilled spirit and at least one Aloaceae source. The ready-to-drink alcoholic beverage may further include a physiologically acceptable component.

Further aspects and advantages will be apparent to those of ordinary skill in the art from a review of the following detailed description. While methods and compositions are susceptible of embodiments in various forms, the description hereafter includes specific embodiments with the understanding that the disclosure is illustrative, and is not intended to limit the disclosure to the specific embodiments described herein.

### DETAILED DESCRIPTION

The inventor has identified a new ready-to-drink alcoholic beverage composition that reduces alcohol-induced indigestion, promotes hydration, reduces inflammation, and helps with glucose rebound. The inventor has further identified a beverage premix composition that can be mixed with any suitable beverage (e.g. a distilled spirit) that reduces indigestion, promotes hydration, reduces inflammation, and helps with glucose rebound.

The disclosure provides a ready-to-drink alcoholic beverage including a distilled spirit and at least one Aloaceae source. In some embodiments, the disclosure provides a beverage premix including the at least one Aloaceae source that can be used to mix with any suitable beverage, such as a distilled spirit. Advantageously, and surprisingly, the alcoholic beverage simultaneously provides the consumer with the benefits generally associated with the consumption of alcohol, in addition to the benefits of the Aloaceae source.

As used herein, a “ready-to-drink” beverage refers to a beverage is suitable for consumption as is. The beverage does not need to be diluted or further mixed prior to consumption.

As used herein, a beverage “premix” refers to a composition that is further diluted or mixed with an additional component prior to consumption. For example, in embodiments, the beverage premix can be further mixed with any of the distilled spirits described herein. In embodiments, the beverage premix is free of a distilled spirit. In embodiments, the beverage premix, according to the disclosure, includes at least one Aloaceae source, as described herein. In embodiments, the beverage premix can further include any one or more of the physiologically acceptable components, as described herein. The amount of the Aloaceae source and/or any physiologically acceptable components present in the beverage premix can be determined by adjusting any of the ranges disclosed herein for the ready-to-drink alcoholic beverage such that the alcoholic component (i.e., the distilled spirit) is no longer present. For example, a ready-to-drink alcoholic beverage comprising 75% distilled spirit, 10% Aloaceae source, and 15% physiologically acceptable component, by volume, has a corresponding beverage premix comprising 40% Aloaceae source and 60% physiologically acceptable component, by volume.

In accordance with the invention, the proof of the ready-to-drink beverage is in a range of between about 5 proof to about 150 proof, about 10 proof to about 100 proof, about 15 proof to about 75 proof, about 20 proof to about 70 proof, about 30 proof to about 65 proof, about 40 proof to about 60 proof, or about 45 proof to about 55 proof, for example at least 5 proof, at least 10 proof, at least 15 proof, at least 18 proof, at least 20 proof, at least 30 proof, at least 40 proof, at least 45 proof, at least 50 proof, at least 55 proof, at least 60 proof, at least 100 proof, or at least 150 proof. In preferred embodiments, the ready-to-drink beverage has a proof between about 40 proof and about 60 proof, for example, about 50 proof.

The term “proof” or “alcohol proof” is a measure of the content of the ethyl alcohol (i.e. ethanol) in an alcoholic beverage. In the United States, proof is defined as twice the percentage of alcohol by volume. For example, 100 proof whisky contains 50% alcohol by volume, and 86 proof whisky contains 43% alcohol by volume.

As used herein, a “distilled spirit” refers to the broad category of alcoholic beverages that include the process of distillation during production in order to purify the spirit and raise its ABV. Generally, distilled spirits have an alcohol content greater than at least 20% by volume, for example 25% by volume, 30% by volume, 40% by volume, 50% by volume, 60% by volume, 80% by volume, or 100% by volume. Distilled spirits are classified into a number of classes, which are then classified into a number of types of spirits. For example, vodka is a particular type of neutral spirit, which is a class of distilled spirits. Examples of classes of distilled spirits, as taught by the Alcohol and Tobacco Tax and Trade Bureau (TTB), include neutral spirits, whisky, gin, brandy, blended applejack, rum, tequila, mescal, and liqueur. Each of these classes can also be flavored with natural or artificial flavoring ingredients. Examples of types of neutral spirits include vodka and grain spirits.

In accordance with the invention, the ready-to-drink alcoholic beverage includes a distilled spirit. In embodiments, the distilled spirit is selected from the group comprising neutral spirits, whisky, gin, brandy, blended applejack, rum, tequila, mescal, liqueur, or any combination thereof. In an alternative embodiment, the distilled spirit is selected from the group consisting of neutral spirits, whisky, gin, brandy, blended applejack, rum, tequila, mescal, or any combination thereof. In embodiments, the distilled spirit is flavored. In preferred embodiments, the distilled spirit is a neutral spirit. In preferred embodiments, the distilled spirit is vodka.

Vodka is defined as a neutral spirit distilled or treated after distillation with charcoal or other materials so as to be without distinctive character, aroma, taste, or color. Generally vodka is distilled from any material at or above 95% alcohol by volume, that is, 190 proof. If bottled, it is bottled at no less than 40% alcohol by volume, that is, 80 proof.

In one aspect, the distilled spirit is substantially free of sugar, dextrose (i.e. glucose), levulose (i.e. fructose), or a combination thereof. In another aspect, the ready-to-drink alcoholic beverage is substantially free of sugar, dextrose, levulose, or a combination thereof. As used herein, the term “substantially free of sugar, dextrose, levulose, or a combination thereof” means the composition contains less than 2.5% by weight, less than 2% by weight, and/or less than 1% by weight sugar, dextrose, levulose, or a combination thereof.

In another aspect, the ready-to-drink alcoholic beverage includes sugar, dextrose, levulose, or a combination thereof. Without intending to be bound by theory, it is believed that the addition of sugar, dextrose, and/or levulose can assist in glucose rebound. In embodiments, the ready-to-drink alcoholic beverage includes sugar, dextrose, levulose, or a combination thereof in an amount ranging from about 0.5 vol % to about 5.0 vol %, about 1.0 vol % to about 4.0 vol %, or about 2.0 vol % to about 3.0 vol %, for example about 0.5 vol %, about 1.0 vol %, about 1.5 vol %, about 2.0 vol %, about 2.5 vol %, about 3.0 vol %, about 3.2 vol %, about 3.5 vol %, about 3.7 vol %, about 4.0 vol %, about 4.5 vol %, or about 5 vol %.

In embodiments, the proof of distilled spirit is in a range of about 40 proof to about 200 proof, about 50 proof to about 150 proof, about 55 proof to about 100 proof, about 60 proof to about 100 proof, or about 75 proof to 100 proof, for example about 40 proof, about 50 proof, about 75 proof, about 80 proof, about 90 proof, about 100 proof, about 150 proof, or about 200 proof. In preferred embodiments, the distilled spirit is at least about 80 proof.

The distilled spirit may or may not be organic. In some embodiments, the distilled spirit is organic. As used herein, the term “organic” indicates that the spirit meets both TTB and United States Department of Agriculture (USDA) organic regulations. That is, the spirit must be made from at least 95% organically produced and certified agricultural ingredients (e.g. grains, agricultural flavoring agents, etc.). Any non-agricultural (i.e. nonorganic) ingredients (e.g. citric acid, ascorbic acid, xanthan gum, etc.) must be specifically allowed on the National List of Allowed and Prohibited Substances (hereafter, “National List”) provided by the USDA, and may not exceed a combined 5% of the total product, excluding water and salt.

In other embodiments, the distilled spirit is made with organic ingredients. As used herein, the term “made with organic” indicates that the spirit meets both TTB and USDA “made with” regulations. That is, at least 70% of the ingredients must be certified organic, but other agricultural ingredients (e.g. flavoring agents), are not required to be organic. Non-agricultural ingredients must be specifically allowed on the National List. Both “organic” and “made with organic” spirits must not include an ingredient produced through genetic engineering or other prohibited methods.

Expressed in terms of percent by volume of the ready-to-drink alcoholic beverage, the distilled spirit is present in a range of about 5% to about 80%, about 10% to about 75%, about 15% to about 60%, or about 20% to about 50%, for example, at least 5%, at least 10%, at least 15%, at least 20%, at least 25%, at least 30%, at least 40%, at least 50%, at least 75%, or at least 80%. In embodiments, the distilled spirit is present in a range of about 20% to about 25% by volume. In embodiments, the distilled spirit is present in an amount sufficient to provide a ready-to-drink alcoholic beverage that is at least about 18 proof. In preferred embodiments, the distilled spirit is present in an amount sufficient to provide a ready-to-drink alcoholic beverage that is at least about 50 proof.

The amount of distilled spirit needed to obtain a desired proof can be determined by dividing the desired proof by the proof of the undiluted distilled spirit. For example, to provide a 50 proof (i.e. 25% alcohol by volume) ready-to-drink alcoholic beverage using an 80 proof (i.e. 40% alcohol by volume) distilled spirit, the distilled spirit would be included at an amount of 62.5% by volume of the ready-to-drink beverage. The remaining 37.5% by volume of the beverage would include the at least one Aloaceae source and any physiologically acceptable component, as described herein.

In all embodiments of the invention, the ready-to-drink beverage and/or the beverage premix comprise at least one Aloaceae source, for example, at least one Aloe L. source. The Aloe L. source can be selected from the group consisting of Aloe vera, Aloe arborescens, Aloe ferox, Aloe graminicola, Aloe perryi, Aloe schoenlandi, Aloe secundiflora, Aloe succotrina, and combinations thereof. In a preferred embodiment, the Aloaceae source is an aloe vera source.

As used herein, “Aloe L.” and “Aloe” are used interchangeably.

As used herein, the terms “Aloe vera,” “A. vera,” and “aloe vera” are used interchangeably. Similarly, the terms “Aloe ferox,” “A. ferox,” and “aloe ferox” are used interchangeably. Any reference to a species belonging to the Aloe plant genus may be made in any of these three formats without changing the meaning of the term.

As used herein, an “Aloaceae source” refers to any source comprising a component or constituent that is derived, isolated, or extracted from a species of the Aloaceae plant family. In preferred embodiments, the Aloaceae source may be any source comprising a component or constituent that is derived, isolated, or extracted from a species of the Aloe L. plant genus, such as a juice, oil, concentrate, gel, extract, powder, pulp, or any combination thereof. In preferred embodiments, the Aloaceae source is an aloe vera source. The aloe vera source may comprise aloe vera juice, aloe vera oil, aloe vera concentrate, aloe vera gel, aloe vera extract, aloe vera powder, aloe vera pulp, or any combination thereof. Suitable aloe vera sources include aloe vera drinks such as Aloe H2O or powdered Aloe Mix n' Go, or more concentrated forms of aloe vera such as Aloe Vera Juice, Aloe Vera Gel, and Whole Leaf Concentrate (Lily of the Desert; Denton, Tex.). Additional suitable aloe vera sources include the beverages provided by ALO® Drink, such as ALO® Original, ALO® Light, ALO® Pulp-Free, ALO® Essentials, and Aloe Coco (ALO® Drink; San Francisco, Calif.). Other suitable commercially available aloe vera sources include aloe vera dietary supplements which are typically provided in capsule or powder form. In embodiments, the Aloaceae source is an aloe ferox source. The aloe ferox source may comprise aloe ferox juice, aloe ferox oil, aloe ferox concentrate, aloe ferox gel, aloe ferox extract, aloe ferox powder, aloe ferox pulp, or any combination thereof. Suitable aloe ferox sources include, but are not limited to, beverages comprising aloe ferox gel, aloe ferox dietary supplements, or Hawaii Pharm Extract (Hawaii Pharm LLC). In embodiments, the Aloaceae source comprises both an aloe vera source and an aloe ferox source.

In embodiments, the Aloaceae source is organic, that is, the Aloaceae source meets USDA organic regulations. In embodiments, the Aloaceae source is made with organic ingredients, that is, the Aloaceae source meets USDA “made with” regulations.

In embodiments, the Aloaceae source includes pulp. In alternative embodiments, the Aloaceae source is pulp-free. As used herein, “pulp” refers to the vesicles of the leaf from which the Aloaceae source can be extracted.

In embodiments, the Aloaceae source is substantially free of aloin. As used herein, “substantially free of aloin” means the Aloaceae source comprises less than 10 ppm aloin, less than 5 ppm aloin, less than 1 ppm aloin, less than 0.1 ppm aloin, less than 0.01 ppm aloin, and/or less than 0.001 ppm aloin. In preferred embodiments, the Aloaceae source comprises less than 1 ppm aloin.

The amount of aloe mucilaginous polysaccharides (AMPs) can be used to “standardize” the content of the Aloaceae source in the ready-to-drink beverage and/or beverage premix according to the disclosure. For example, when the Aloaceae source is provided in the form of a juice, oil, concentrate, gel, extract, powder, pulp, or a combination thereof derived from an species of the Aloaceae plant family, the concentration of AMPs in the ready-to-drink alcoholic beverage according to the invention in terms of amount of AMPs per milliliter of the beverage can be in a range of about 0.05 mg/ml to about 2.5 mg/ml, about 0.1 mg/ml to about 2.0 mg/ml, about 0.2 mg/ml to about 1.5 mg/ml, about 0.3 mg/ml to about 1 mg/ml, about 0.4 mg/ml to about 0.7 mg/ml, or about 0.5 mg/ml to about 0.6 mg/ml, for example, about 0.05 mg/ml, about 0.075 mg/ml, about 0.1 mg/ml, about 0.2, about 0.3 mg/ml, about 0.4 mg/ml, about 0.5 mg/ml, about 0.7 mg/ml, about 1 mg/ml, about 1.25 mg/ml, about 1.5 mg/ml, or about 2.0 mg/ml. In embodiments, the concentration of AMPs in the ready-to-drink alcoholic beverage is about 0.07 mg/mi. In a preferred embodiment, the concentration of AMPs in the ready-to-drink alcoholic beverage is at least about 0.5 mg/mi.

Alternatively, when the Aloaceae source is provided in the form of a beverage prepared with a species of the Aloaceae plant family, for example, aloe vera (e.g. ALO® Original, Aloe H2O, etc.), expressed in terms of percent by volume of the ready-to-drink alcoholic beverage, the Aloaceae source may be present in a range of about 10% to about 90%, about 15% to about 80%, about 20% to about 75%, about 25% to about 70%, about 30% to about 65% or about 40% to about 60%, for example, about 10%, about 15%, about 20%, about 30%, about 40%, about 45%, about 50%, about 55%, about 60%, about 75%, about 80%, or about 90%. In preferred embodiments, the Aloaceae source may be present in range of about 40% to about 60% by volume of the ready-to-drink alcoholic beverage.

In preferred embodiments, the ready-to-drink alcoholic beverage and/or the beverage premix further comprises a physiologically acceptable component. As used herein, the term “physiologically acceptable component” broadly refers to any component suitable for use in a beverage that further enhances or preserves the beverage by providing, for example, flavor, nutrients, or color. Examples of a physiologically acceptable component include, but are not limited to, water, natural fruit juice, natural vegetable juice, natural sweeteners, artificial sweeteners, inorganic salt, mineral, vitamin, fruit extract, vegetable extract, herb, colorant, preservative, emulsifier and/or thickening agent, or any combination thereof. In embodiments, the physiologically acceptable component is organic, that is, the physiologically acceptable component meets the USDA organic regulations. In other embodiments, the physiologically acceptable component is made with organic ingredients, that is, the physiologically acceptable component meets the USDA “made with” regulations.

In embodiments, the physiologically acceptable component includes water. The water may be selected from distilled water, purified water, alkaline water, mineral water, coconut water, sparkling water, flavored water, or any combination thereof. In embodiments, the water comprises electrolytes. In embodiments, the ready-to-drink beverage includes alkaline water having a pH of at least about 9. In embodiments the ready-to-drink beverage includes alkaline water having a pH of at least about 9 in an amount ranging from about 50% to about 80% by volume.

In embodiments, the physiologically acceptable component includes natural fruit juice or fruit extract. In embodiments, the physiologically acceptable component includes synthetic fruit juice or fruit extract. The natural or synthetic fruit juice or fruit extract may be isolated or derived from fruits such as peach, pineapple, lemon, lime, orange, tangerine, grapefruit, citrus fruits, raspberry, strawberry, blueberry, cranberry, waxberry, mulberry, black currant, cherry, apple, pear, prickly pear, passion fruit, pomegranate, mango, mangosteen, red grape, white grape, papaya, banana, coconut, cantaloupe, watermelon, plum, sea buckthorn or any combination thereof. In embodiments, the physiologically acceptable component includes coconut extract. In embodiments, the ready-to-drink beverage includes coconut extract in an amount ranging from about 0.005% to about 0.5% by volume, for example about 0.005%, about 0.01%, about 0.015%, about 0.02%, about 0.025%, about 0.03%, about 0.04% about 0.05%, about 0.075%, about 0.1%, about 0.2%, about 0.3%, about 0.4%, or about 0.5% by volume.

In embodiments, the physiologically acceptable component includes natural vegetable juice or vegetable extract. The natural vegetable juice or vegetable extract may be isolated or derived from vegetables such as cucumber, tomato, carrot, wheatgrass, broccoli, cabbage, celery, spinach, or any combination thereof.

In embodiments, the physiologically acceptable component includes a natural sweetener. The natural sweetener may be selected from the group including sucrose, dextrose, levulose, cane sugar, raw honey, honey, erythritol, stevia leaf extract, coconut sugar, maple syrup, brown rice syrup, agave nectar, high-fructose corn syrup, glycosyl-steviosides (Stevie rebaudiana), Luo Han Guo (Monk) fruit extract, or any combination thereof. In embodiments, the physiologically acceptable component includes raw honey. In embodiments, the ready-to-drink beverage includes raw honey in an amount ranging from about 2% to about 5% by volume, by example, about 2%, about 2.5%, about 3%, about 3.5%, about 4%, about 4.5%, or about 5% by volume. In addition to its natural sweetening characteristics, raw honey can also be as a natural preservative.

In embodiments, the physiologically acceptable component includes an artificial sweetener. The artificial sweetener may be selected from the group including aspartame, sucralose, acesulfame potassium, saccharin, xylitol, sorbitol, or any combination thereof.

In embodiments, the physiologically acceptable component includes an inorganic salt. The inorganic salt may be selected from the group including sodium chloride, sodium bicarbonate, calcium chloride, magnesium sulfate, or any combination thereof.

In embodiments, the physiologically acceptable component includes a mineral. The mineral may be selected from the group including sodium, potassium, calcium, magnesium, phosphate, iron, fluoride, iodine, chromium, selenium, zinc or any combination thereof.

In embodiments, the physiologically acceptable component includes a vitamin. The vitamin can include natural and/or synthetic antioxidants. The vitamin may be selected from ascorbic acid, retinol, retinoid, tocopherol, calciferol, thiamin, riboflavin, folic acid, biotin, choline, and their derivatives or any combination thereof.

In embodiments, the physiologically acceptable component includes an herb. The herb may be selected from peppermint, chamomile, spearmint, dandelion, Echinacea, green tea, red clover blossoms, buckthorn bark, borage leaf, marshmallow root, ginger, Pau d'Arco, blessed thistle, milk thistle, slippery elm bark, fennel, carum (i.e. caraway), anise, hops, licorice, or any combination thereof. In a preferred embodiment, the herb is milk thistle. In embodiments, the physiologically acceptable component includes ginger, fennel, or a combination thereof. In an embodiment, the physiologically acceptable component includes ginger. In embodiments, the ready-to-drink beverage includes ginger in an amount ranging from about 0.005% to about 0.05% by volume, for example about 0.005%, about 0.01%, about 0.015% about 0.02%, about 0.025%, about 0.03%, about 0.04% or about 0.05% by volume. In an embodiment, the physiologically acceptable component includes fennel. In embodiments, the ready-to-drink beverage includes fennel in an amount ranging from about 0.005% to about 0.05% by volume, for example about 0.005%, about 0.01%, about 0.015%, about 0.02%, about 0.025%, about 0.03%, about 0.04% or about 0.05% by volume

In embodiments, the physiologically acceptable component includes a colorant. The colorant may be synthetic or natural, such as artificial food dyes and conventional colorants such as riboflavin, spirulina extract, carmine, curcumin, caramel, and beta-carotene, as well as fruit, vegetable, and/or plant extracts such as, radish, beetroot, carrot, grape, grape skin, hibiscus, red cabbage, black currant, or any combination thereof.

In embodiments, the physiologically acceptable component includes a preservative. The preservative may be selected from citric acid, sodium citrate, malic acid, potassium sorbate, sodium benzoate, or any combination thereof. In embodiments, the physiologically acceptable component includes citric acid. In embodiments, the ready-to-drink beverage includes citric acid in an amount ranging from about 0.001% by volume to about 0.015% by volume, for example about 0.001%, about 0.005%, about 0.007%, about 0.009%, about 0.01%, about 0.012%, or about 0.015% by volume.

In embodiments, the physiologically acceptable component includes emulsifiers and/or thickening agents. The emulsifier and/or thickening agent may be selected from carboxymethylcellulose, gellan gum, xanthan gum, pectin, maltodextrin, carrageenan, or any combination thereof.

Expressed in terms of percent by volume of the ready-to-drink alcoholic beverage, the physiologically acceptable component is present in a range of about 5% to about 80%, about 10% to about 75%, about 15% to about 50%, or about 20% to about 30%, for example, about 5%, about 10%, about 15%, about 20%, about 25%, about 30%, about 40%, about 50%, about 70%, about 75%, or about 80%. In embodiments, the ready-to-drink beverage includes about 70% physiologically acceptable component. In embodiments, the physiologically acceptable component includes alkaline water, raw honey, ginger, fennel, coconut extract, or any combination thereof. In preferred embodiments, the ready-to-drink beverage comprises about 20% to about 30% by volume the physiologically acceptable component.

In embodiments, the ready-to-drink alcoholic beverage comprises a distilled spirit, an Aloaceae source, and a physiologically acceptable component. In embodiments, the ready-to-drink alcoholic beverage comprises at least about 0.5 mg/ml AMPs and is at least about 50 proof. In embodiments, the ready-to-drink beverage comprises at least about 0.05 mg/mL AMPs and is at least about 18 proof.

Advantageously, the ready-to-drink beverage of the disclosure provides the consumer with the desired effect due to the consumption of alcohol (e.g. euphoria, decreased social anxiety, improved self-confidence, etc.), while simultaneously imparting the beneficial effects of the Aloaceae source by reducing alcohol-induced indigestion, promoting hydration, and reducing inflammation. Furthermore, in embodiments, the beverage can contain added glucose to assist in glucose rebound. Additionally, the beverage premix of the disclosure provides the consumer with the ability to particularly select the distilled spirit with which to mix the premix, while maintaining the aforementioned benefits of the effects due to the consumption of alcohol and the Aloaceae source.

The ready-to-drink alcoholic beverage in accordance with the disclosure can be better understood in light of the following examples, which are merely intended to illustrate the beverage of the disclosure and are not meant to limit the scope thereof in any way.

### EXAMPLES

### Example 1

A ready-to-drink alcoholic beverage according to the disclosure was prepared as provided by the composition below:

| | % by |
|---|---|
| Ingredient | volume |
| Alkaline Water (pH ≥9) | 66.4 |
| Vodka (80 proof) | 22.5 |
| Aloe Vera Gel (Lily of the Desert) | 7.4 |
| Raw Honey | 3.7 |
| Ginger | 0.025 |
| Fennel | 0.015 |
| Coconut Extract | 0.010 |
| Citric acid | 0.009 |
| Total | 100 |
| Proof | 18 |
| AMPs (mg/ml) | 0.074 |

### Example 2

A beverage premix according to the disclosure was prepared as provided by the composition below:

| | % by |
|---|---|
| Ingredient | volume |
| Alkaline Water (pH ≥ 9) | 85.6 |
| Aloe Vera Gel (Lily of the Desert) | 9.5 |
| Honey | 4.7 |
| Ginger | 0.032 |
| Fennel | 0.019 |
| Coconut Extract | 0.013 |
| Citric acid | 0.012 |
| Total | 100 |
| AMPs (mg/ml) | 0.095 |

### Example 3

A ready-to-drink alcoholic beverage according to the disclosure is prepared as provided by the composition below:

| Ingredient | % by volume |
|---|---|
| Vodka (80 proof, organic) | 60 |
| Aloe Vera Juice (Lily of the Desert) | 30 |
| Aloe Ferox Extract (Hawaii Pharm LLC) | 2 |
| Mineral water | 3 |
| Coconut water | 5 |
| Total | 100 |
| Proof | 48 |
| AMPs (mg/ml) | 0.30 |

### Example 4

A ready-to-drink alcoholic beverage according to the disclosure is prepared as provided by the composition below:

| Ingredient | % by volume |
|---|---|
| Vodka (100 proof) | 50 |
| Aloe Vera Gel (Lily of the Desert) | 50 |
| Total | 100 |
| Proof | 50 |
| AMPs (mg/ml) | 0.50 |

### Example 5

A ready-to-drink alcoholic beverage according to the disclosure is prepared as provided by the composition below:

| Ingredient | % by volume |
|---|---|
| Vodka (100 proof, made with | 50 |
| organic ingredients) | |
| ALO ® Light | 45 |
| Mineral water | 2 |
| Honey | 1 |
| Ginger | 1 |
| Cucumber extract | 1 |
| Total | 100 |
| Proof | 50 |

1. A ready-to-drink alcoholic beverage comprising:
(a) a distilled spirit; and,
(b) at least one Aloaceae source.

2. The beverage of claim 1, further comprising a physiologically acceptable component.

3. The beverage of claim 1, wherein the Aloaceae source is an Aloe L. source.

4. The beverage of claim 3, wherein the Aloe L. source is selected from the group consisting of Aloe vera, Aloe arborescens, Aloe ferox, Aloe graminicola, Aloe perryi, Aloe schoenlandi, Aloe secundiflora, Aloe succotrina, and combinations thereof.

5. The beverage of claim 1, wherein the Aloaceae source is an Aloe vera source.

6. The beverage of claim 1, wherein the beverage is at least about 18 proof.

7. (canceled)

8. The beverage of claim 1, wherein the beverage comprises between 0.05 mg/ml and 2.5 mg/ml aloe mucilaginous polysaccharides.

9. (canceled)

10. The beverage of claim 2, wherein the beverage comprises between 20% and 80% by volume the physiologically acceptable component.

11.-14. (canceled)

15. The beverage of claim 2, wherein the physiologically acceptable component is selected from the group consisting of water, natural fruit juice, synthetic fruit juice, natural vegetable juice, natural sweetener, artificial sweetener, inorganic salt, mineral, vitamin, fruit extract, vegetable extract, herb, colorant, preservative, emulsifier and/or thickening agent, and any combination thereof.

16. The beverage of claim 15, wherein the water is selected from the group consisting of distilled water, alkaline water, purified water, mineral water, coconut water, sparkling water, flavored water, and any combination thereof.

17. (canceled)

18. The beverage of claim 15, wherein the fruit extract is selected from a fruit of the group consisting of peach, pineapple, lemon, lime, orange, tangerine, grapefruit, raspberry, strawberry, blueberry, cranberry, waxberry, mulberry, black currant, cherry, apple, pear, passion fruit, pomegranate, mango, mangosteen, red grape, white grape, papaya, banana, coconut, cantaloupe, watermelon, plum, sea buckthorn and any combination thereof.

19. (canceled)

20. (canceled)

21. The beverage of claim 15, wherein the natural sweetener is selected from the group consisting of sucrose, dextrose, levulose, cane sugar, raw honey, erythritol, stevia leaf extract, coconut sugar, maple syrup, brown rice syrup, agave nectar, high-fructose corn syrup, glycosyl-steviosides (Stevie rebaudiana), Luo Han Guo (Monk) fruit extract and any combination thereof.

22.-25. (canceled)

26. The beverage of claim 15, wherein the herb is selected from the group consisting of peppermint, chamomile, spearmint, dandelion, Echinacea, green tea, red clover blossoms, buckthorn bark, borage leaf, marshmallow root, ginger, Pau d'Arco, blessed thistle, milk thistle, slippery elm bark, fennel, carum, anise, hops, licorice, and any combination thereof.

27. (canceled)

28. The beverage of claim 26, wherein the physiologically acceptable component comprises ginger, fennel, or a combination thereof.

29. (canceled)

30. The beverage of claim 15, wherein the preservative is selected from the group consisting of citric acid, sodium citrate, malic acid, potassium sorbate, sodium benzoate, and any combination thereof.

31. (canceled)

32. The beverage of claim 1, wherein the distilled spirit is selected from the group consisting of neutral spirits, whisky, gin, brandy, applejack, rum, tequila, mescal, liqueur, and any combination thereof.

33. (canceled)

34. (canceled)

35. The beverage of claim 32, wherein the distilled spirit is a neutral spirit.

36. The beverage of claim 35, wherein the neutral spirit is selected from the group consisting of vodka, grain spirits, and any combination thereof.

37. (canceled)

38. The beverage of claim 1, wherein the Aloaceae source is selected from the group consisting of aloe vera juice, aloe vera oil, aloe vera concentrate, aloe vera gel, aloe vera extract, aloe vera powder, aloe vera pulp, and any combination thereof.

39.-44. (canceled)

45. The beverage of claim 1, wherein the distilled spirit between about 75 proof and 100 proof.

46.-54. (canceled)
